(19) United States
(12) Patent Application Publication
(10) Pub. No.: US 2014/0261008 A1
(43) Pub. Date: Sep. 18, 2014

(54) Outdoor Cooker for a Backyard, Campsite and Tailgate Party

(71) Applicants: Charles J. Howard, JR., Thornton, CO (US); George Austin Kremer, Superior, CO (US)

(72) Inventors: Charles J. Howard, JR., Thornton, CO (US); George Austin Kremer, Superior, CO (US)

(21) Appl. No.: 13/827,804

(22) Filed: Mar. 14, 2013

(51) Int. Cl. A47J 37/07; A47J 37/06

(52) U.S. Cl. CPC A47J 37/0727; A47J 37/0682
USPC 99/340; 99/443 R; 99/422

(57) ABSTRACT

An outdoor cooker having a heavy metal, circular housing with an open top and a closed bottom. A grill sleeve and grill pivot tube are attached to the housing and to a circular grill. The grill pivot tube is used to pivot the grill above the open top of the housing and receiving and cooking food items on the grill. The cooker also including a skillet sleeve and skillet pivot tube attached to the housing and a circular skillet. The skillet pivot tube is used to pivot the skillet above the open top of the housing for cooking food items. The cooker also includes leg tubes attached to the outside of the housing for receiving two or more removable vertical legs. The legs are used to support the housing on a ground surface.

### BACKGROUND OF THE INVENTION

(a) Field of the Invention

This invention relates to an outdoor cooker for grilling and frying foods thereon and more particularly but not by way of limitation, to an outdoor cooker having an open top, heavy tire rim housing adapted for receiving firewood, charcoal or a gas burner therein. The housing includes a horizontal, rotatable, circular grill and a horizontal, rotatable, circular skillet. The grill and skillet can be rotated individually above the open top of the housing for cooking food items.

(b) Discussion of Prior Art

Heretofore, there have been a number of outdoor cookers that have been patented. For example, U.S. Pat. No. 3,613,657 to Wilska discloses a portable outdoor cooking unit having a removable cooking grill cartridge packet with non-combustible briquets. In U.S. Pat. No. 4,686,958 to Skelton et al, a versatile outdoor cooker is described having a metal cooking tank for holding a cooking liquid and burner. In U.S. Pat. No. 5,531,154 to Perez, III, a combination outdoor cooker and smoker is illustrated having a cylindrical hollow housing with a support grate and a heat source. In U.S. Pat. No. 6,488,022 to Shingler, a portable, wheel mounted, outdoor cooker is disclosed having a circular heat transfer plate and a plurality of gas burners.

None of these prior art cookers mentioned above provide the unique structure, features, objects and advantages of the subject outdoor cooker as described herein.

### SUMMARY OF THE INVENTION

In view of the foregoing, it is a primary objective of the subject invention to provide a heavy duty, outdoor cooker that can be used at various outdoor locations, such as a home backyard, at a campsite, and attached to the rear of a vehicle and used for a tailgate cooking party.

Another object of the invention is the outdoor cooker includes a rotatable grill for grilling food items and a separate rotatable skillet for frying food items. The feature of the rotatable grill and skillet provide for ease in cooking, particularly for a handicap person or a person in a wheelchair, and without the person having to stand over an open top in the cooker. The cooker can include a gas burner or can be used with charcoal or firewood for cooking.

Yet another object is the outdoor cooker includes removable legs for ease in storage during winter months. Also, the outdoor cooker is made of heavy metal for durability. Also, it can be permanently installed at a campsite for long term use.

The subject invention includes a heavy metal, circular housing, made from a truck tire rim. The housing has an open top and a closed bottom. The circular housing is adapted for receiving firewood, charcoal or a gas grill therein. A vertical grill sleeve is mounted on an outside of the housing. A vertical grill pivot tube is attached to a side of a rotatable, horizontal circular grill. The grill pivot tube is slidably received in the grill sleeve. The grill pivot tube allows the grill to pivot above the open top of the housing for receiving food items thereon to be grilled

A vertical skillet sleeve is mounted on an opposite outside of the housing. A vertical skillet pivot tube is attached to a side of a rotatable, horizontal circular skillet. The skillet pivot tube is slidably received in the skillet sleeve. The skillet pivot tube allows the skillet to pivot above the open top of the housing for receiving food items thereon to be fried.

The outdoor cooker also includes near vertical leg tubes attached to the outside of the housing for receiving a top portion of two or more removable tubular legs. The legs are used to support the housing on a ground surface.

These and other objects of the present invention will become apparent to those familiar with outdoor cookers and the like when reviewing the following detailed description, showing novel construction, combination, and elements as described, and more particularly defined by the claims, it being understood that changes in the embodiments to the disclosed invention are meant to be included as coming within the scope of the claims, except insofar as they may be precluded by any prior art references.

### BRIEF DESCRIPTION OF THE DRAWINGS

The accompanying drawings illustrate complete preferred embodiments in the present invention according to the best modes presently devised for the practical application of the subject outdoor cooker having a rotatable circular grill and a rotatable circular skillet, and in which:

FIG. 1 is a perspective view of the subject outdoor cooker shown in a stored position and prior to use. The cooker broadly includes a heavy metal, circular housing with an open top and mounted on four removable near vertical legs received on a ground surface.

FIG. 2 is another perspective view of the outdoor cooker illustrating a horizontal rotatable circular grill and a horizontal rotatable circular skillet for receipt over the open top of the housing. A portion of the housing has been cut-away to illustrate a gas burner and metal grate mounted in the bottom of the housing.

FIG. 3 is still another perspective view of the outdoor cooker adapted for mounting on a rear of a vehicle for use during a tailgate party.

FIG. 4 is yet another perspective view of the outdoor cooker with the housing mounted on top of a vertical, tubular post and installed for long term use at a campsite.

### DETAILED DESCRIPTION OF THE PREFERRED EMBODIMENTS

In FIG. 1, a perspective view of the subject outdoor cooker is illustrated in a stored position prior to use and having general reference numeral 10. The cooker 10 includes a heavy metal, circular truck tire rim. The truck tire rim is used as a housing 12 and is adapted for receiving firewood, charcoal, a gas burner and the like therein for cooking various food items. Mounted on an outside of the housing 12 is a vertical grill sleeve 14 for receiving a vertical grill tube 16 therein, with the tube 16 rotating on the sleeve 14. The grill tube 16 is attached to a side of a circular metal grill 18 using a metal strap 19.

Mounted on an opposite outside of the housing 12 is a vertical skillet sleeve 20 for receiving a vertical skillet pivot tube 22 therein, with the tube 22 rotating on the sleeve 20. The skillet pivot tube 22 is attached to a side of a circular metal skillet 24 using another metal strap 19. The skillet sleeve 20 can be seen in FIG. 3.

The cooker 10, in this embodiment, includes four leg sleeves 26 for slidably receiving a top portion of four near vertical legs 28. The legs 28 are angled outwardly up to 25 degrees from the vertical for added stability of the cooker 10 and when the cooker 10 is supported on a ground surface 30.

In this drawing, a stop pin 21, with a “D” ring 23 is shown received through the grill sleeve 14 and the grill tube 16 for holding the grill 18 in place prior cooking. The skillet sleeve 20 and skillet pivot tube 22 also include a similar holding device prior to the use of the skillet 24.

In FIG. 2, another embodiment of the outdoor cooker 10 is shown illustrating the horizontal circular grill 18 and the horizontal rotatable circular skillet 24 rotated away from an open top 32 of the housing 12, as indicated by arrows 34. This unique feature of the rotatable grill 18 and the rotatable skillet 24 allow either the grill or skillet to be placed above the open top 32 of the housing 12 for cooking food items. In this drawing, the stop pin 21 has been removed from a pin hole 46, thereby allowing free movement of the grill and skillet. Also shown in this drawing is a portion of the housing 12 cut-away to illustrate a gas burner 35 and a metal grate 38 mounted above a closed bottom 40 in the housing. The gas burner 36 is shown connected to a gas line 42 and a gas tank 44 for supplying fuel to the burner.

In FIG. 3, still another perspective view of the outdoor cooker 10 is shown and adapted for mounting on a rear of a vehicle 48 for use during a tailgate party. In this embodiment, the cooker 10 includes a stationary horizontal arm 50 having first end 52 received inside a trailer hitch tube 54. The trailer hitch tube 54 is mounted under a bumper 56 of the vehicle 48. A horizontal sliding arm 58 is slidably received, as indicated by arrow 60, inside a second end 61 of the stationary horizontal arm 50 and pinned thereto using an arm pin 62. An outwardly extending end of the sliding arm 58 is attached to a bottom of the grill sleeve 14 for allowing the cooker 10 to rotate above the horizontal stationary arm 50 and move into a position as shown in this drawing.

In this drawing and when the stop pins 21 are removed from the sleeves 14 and 20, the grill 18 and skillet 24 are free to rotate away from the open top 32 of the housing 12 for starting a cooking fire therein. Also shown in this drawing are a pair of legs 28 with telescoping lower leg portions 64. The legs 28 and lower leg portions 64 are used for supporting the cooker 10 horizontally on the ground surface 30. The lower leg portions 64 are used for adjusting a length of the legs on uneven ground.

In FIG. 4, yet another perspective view of the outdoor cooker 10 with the housing 12 is shown mounted on top of a vertical, tubular post 66 and used at a campsite as a long term installation. In this embodiment of the invention, charcoal briquettes 68 are shown received on the metal grate 38 for cooking food items on either the grill 18 or the skillet 24, when received over the open top 32 of the housing 12.

It should be mentioned that the subject cooker 10 can include either the grill 18 or the skillet 24 or both, as shown in the drawings. Also, the grill 18 is shown disposed above the skillet 24 in a stored position or their positions can be reversed when mounted on the housing 12. The grill and skillet typically have a diameter in a range of 18 to 28 inches, which is sufficient to completely cover the open top 32 of the housing 12. The open top typically has a diameter in a range of 20 to 24 inches.

While the invention has been particularly shown, described and illustrated in detail with reference to the preferred embodiments and modifications thereof, it should be understood by those skilled in the art that equivalent changes in form and detail may be made therein without departing from the true spirit and scope of the invention as claimed except as precluded by the prior art.

The embodiments of the invention for which as exclusive privilege and property right is claimed are defined as follows:

1. An outdoor cooker adapted for use at various locations, such as a home backyard, a campsite, or a tailgate party, and for receipt on a ground surface, the cooker used for cooking various food items thereon, the cooker comprising:
a circular housing having an open top;
a grill sleeve attached to an outside of the housing;
a grill pivot tube rotatably mounted in the grill sleeve;
a circular grill, the grill pivot tube attached to an outside of the grill, the grill pivot tube used for rotating the grill above the open top of the housing and adapted for cooking the food items thereon;
a skillet sleeve attached on an opposite outside of the housing;
a skillet pivot tube rotatably mounted in the skillet sleeve; and
a circular skillet, the skillet pivot tube attached to an outside of the skillet, the skillet pivot tube used for rotating the skillet above the open top of the housing and adapted for cooking the food items thereon.

2. The outdoor cooker as described in claim 1 wherein the grill has a diameter greater than a diameter of the open top of the circular housing to prevent food items from dropping into the housing when the grill is disposed above the open top of the housing.

3. The outdoor cooker as described in claim 1 wherein the skillet has a diameter greater than a diameter of the open top of the circular housing to prevent food items from dropping into the housing when the skillet is disposed above the open top of the housing.

4. The outdoor cooker as described in claim 1 further including metal grate mounted next to the bottom of the housing.

5. The outdoor cooker as described in claim 1 further including a gas burner mounted in a bottom of the housing, the gas burner connected to a gas tube and a gas tank for supplying gas to the burner.

6. The outdoor cooker as described in claim 1 further including a horizontal sliding arm slidably received in a horizontal stationary arm, one end of the stationary arm adapted for mounting on a rear of a vehicle, one end of the sliding arm attached to the grill sleeve, the stationary arm and the sliding arm used for supporting the housing next to the rear of the vehicle.

7. The outdoor cooker as described in claim 6 further including two vertical legs with telescoping lower leg portions for adjusting a length of the legs when engaging an uneven ground surface.

8. The outdoor cooker as described in claim 1 further including a plurality of legs attached to a portion of the housing for supporting the housing thereon

9. The outdoor cooker as described in claim 1 further including a vertical post attached to the housing and supporting the housing thereon.

10. The outdoor cooker as described in claim 1 wherein the grill sleeve and grill pivot tube and the skillet sleeve and the skillet pivot tube include a stop pin with “D” ring for holding the grill and skillet in a stored position above the open top of the housing.

11. An outdoor cooker adapted for use at various locations, such as a home backyard, a campsite or a tailgate party, and for receipt on a ground surface, the cooker used for cooking various food items thereon, the cooker comprising:
a heavy metal, circular housing having an open top and a closed bottom;
a vertical grill sleeve attached to an outside of the housing;
a vertical grill pivot tube rotatably mounted in the grill sleeve; and
a circular grill, the grill pivot tube attached to an outside of the grill, the grill pivot tube for rotating the grill above the open top of the housing and cooking the food items thereon, the grill having a diameter greater than a diameter of the open top of the housing.

12. The outdoor cooker as described in claim 11 further including:
a skillet sleeve attached on an opposite outside of the housing;
a skillet pivot tube rotatably mounted in the skillet sleeve; and
a circular skillet, the skillet pivot tube attached to an outside of the skillet, the skillet pivot tube for rotating the skillet above the open top of the housing for cooking the food items thereon, the skillet having a diameter greater than a diameter of the open top of the housing.

13. The outdoor cooker as described in claim 11 further including a horizontal sliding arm slidably received in a horizontal stationary arm, one end of the stationary arm adapted for mounting on a rear of a vehicle, one end of the sliding arm attached to the grill sleeve, the stationary arm and the sliding arm used for supporting the housing next to the rear of the vehicle.

14. The outdoor cooker as described in claim 11 further including two legs with telescoping lower leg portions for adjusting a length of the legs when engaging an uneven ground surface.

15. The outdoor cooker as described in claim 11 further including a plurality of legs attached to a portion of the housing for supporting the housing thereon

16. The outdoor cooker as described in claim 1 further including a vertical post attached to the housing and supporting the housing thereon.

17. An outdoor cooker adapted for use at various locations, such as a home backyard, a campsite or a tailgate party, and for receipt on a ground surface, the cooker used for cooking various food items thereon, the cooker comprising:
a heavy metal, circular housing having an open top and a closed bottom;
a vertical grill sleeve attached to an outside of the housing;
a vertical grill tube rotatably mounted in the grill sleeve;
a circular grill, the grill tube attached to an outside of the grill, the grill tube for rotating the grill above the open top of the housing and cooking the food items thereon, the grill having a diameter greater than a diameter of the open top of the housing.
a vertical skillet sleeve attached on an opposite outside of the housing;
a vertical skillet pivot tube rotatably mounted in the skillet pivot sleeve;
a circular skillet, the skillet pivot tube attached to an outside of the skillet, the skillet pivot tube for rotating the skillet above the open top of the housing for cooking the food items thereon, the skillet having a diameter greater than a diameter of the open top of the housing; and
a plurality of legs attached to the housing, the legs adapted for supporting the housing on the ground surface.

18. The outdoor cooker as described in claim 17 further including a horizontal sliding arm slidably received in a horizontal stationary arm, one end of the stationary arm adapted for mounting on a rear of a vehicle, one end of the sliding arm attached to the grill sleeve, the stationary arm and the sliding arm used for supporting the housing next to the rear of the vehicle.

19. The outdoor cooker as described in claim 18 further including two legs with telescoping lower leg portions for adjusting a length of the legs when engaging an uneven ground surface.

20. The outdoor cooker as described in claim 17 further including metal grate and a gas burner mounted in a bottom of the housing, the gas burner connected to a gas tube and a gas tank for supplying gas to the burner.
